(19) United States
(12) Patent Application Publication
(10) Pub. No.: US 2026/0309650 A1
(43) Pub. Date: Oct. 8, 2026

(54) IMAGE PROCESSING APPARATUS, IMAGE PROCESSING METHOD, AND IMAGE PROCESSING PROGRAM

(71) Applicant: FUJIFILM Corporation, Tokyo (JP)

(72) Inventor: Takanori HIGUMA, Tokyo (JP)

(73) Assignee: FUJIFILM Corporation, Tokyo (JP)

(21) Appl. No.: 19/578,923

(22) Filed: Mar. 26, 2026

(30) Foreign Application Priority Data
Apr. 2, 2025 (JP) 2025-061147

(51) Int. Cl. G01N 23/046

(52) U.S. Cl. CPC G01N 23/046; G01N 2223/401; G01N 2223/408

(57) ABSTRACT

An image processing apparatus is an image processing apparatus that generates a tilt image, which is an image of an inclined cross section inclined by tilt-rotating a tomographic image representing an axial cross section obtained by imaging a subject with a tomographic imaging apparatus, the image processing apparatus including: a processor, in which the processor is configured to: perform a first control to display the tomographic image and perform a second control to display a range used for generating the tilt image in the tomographic image in an identifiable manner.

### CROSS-REFERENCE TO RELATED APPLICATION

This application claims priority from Japanese Patent Application No. 2025-061147, filed on Apr. 2, 2025, the entire disclosure of which is incorporated herein by reference.

### BACKGROUND

### 1. Technical Field

The present disclosure relates to an image processing apparatus, an image processing method, and an image processing program.

### 2. Description of the Related Art

JP2012-024233A discloses a CT apparatus that generates a tilt image without using a tilt mechanism of a gantry.

### SUMMARY

In imaging a tomographic image such as a CT image, a tomographic image representing an axial cross section is displayed on a display, and a user such as a radiologist can check an imaging situation. In addition, as described in JP2012-024233A, a technique of generating a tilt image (also referred to as a digital tilt image) without using a tilt mechanism of a gantry is known. In a case where a tilt image is generated based on a tomographic image after the imaging of the tomographic image, the user may recognize that image quality of the tilt image does not satisfy image quality required for image interpretation after the generation of the tilt image. In this case, the user cannot determine whether or not to perform re-imaging of the tomographic image until the generation of the tilt image is completed, and thus the subject has to wait until the generation of the tilt image is completed. Therefore, it is preferable to be able to check whether or not the tilt image can be appropriately generated before the generation of the tilt image.

In the technique described in JP2012-024233A, the user can check a reconstruction range of the tilt image in a case where a scout image is captured before the imaging of the tomographic image. However, the tilt image may not be appropriately generated due to misregistration of the subject or the like. In this case, in the technique described in JP2012-024233A, it is not possible to check whether or not the tilt image can be appropriately generated until the imaging of the tomographic image is completed and the generation of the tilt image is completed.

The present disclosure has been made in consideration of the above circumstances, and an object of the present disclosure is to provide an image processing apparatus, an image processing method, and an image processing program that enable a user to check whether or not a tilt image can be appropriately generated before the generation of the tilt image.

According to an aspect of the present disclosed technology, there is provided an image processing apparatus that generates a tilt image, which is an image of an inclined cross section inclined by tilt-rotating a tomographic image representing an axial cross section obtained by imaging a subject with a tomographic imaging apparatus, the image processing apparatus comprising: a processor, in which the processor is configured to perform a first control to display the tomographic image and perform a second control to display a range used for generating the tilt image in the tomographic image in an identifiable manner.

According to another aspect of the present disclosed technology, there is provided an image processing method executed by a processor included in an image processing apparatus that generates a tilt image, which is an image of an inclined cross section inclined by tilt-rotating a tomographic image representing an axial cross section obtained by imaging a subject with a tomographic imaging apparatus, the image processing method comprising: performing a first control to display the tomographic image; and performing a second control to display a range used for generating the tilt image in the tomographic image in an identifiable manner.

According to still another aspect of the present disclosed technology, there is provided an image processing program causing a processor included in an image processing apparatus that generates a tilt image, which is an image of an inclined cross section inclined by tilt-rotating a tomographic image representing an axial cross section obtained by imaging a subject with a tomographic imaging apparatus, to execute a process comprising: performing a first control to display the tomographic image; and performing a second control to display a range used for generating the tilt image in the tomographic image in an identifiable manner.

According to the present disclosure, it is possible for a user to check whether or not a tilt image can be appropriately generated before the generation of the tilt image.

### BRIEF DESCRIPTION OF THE DRAWINGS

FIG. 1 is a schematic diagram showing an example of a configuration of a tomographic imaging system.

FIG. 2 is a block diagram showing an example of a hardware configuration of a console.

FIG. 3 is a diagram for describing an inclined cross section.

FIG. 4 is a diagram for describing a range not used for generating a tilt image in a tomographic image.

FIG. 5 is a block diagram showing an example of a functional configuration of the console.

FIG. 6 is a diagram showing an example of a display screen.

FIG. 7 is a diagram showing an example of a display screen.

FIG. 8 is a diagram showing an example of a display screen.

FIG. 9 is a flowchart showing an example of tomographic imaging processing.

### DETAILED DESCRIPTION

Hereinafter, examples of embodiments for implementing the technique of the present disclosure will be described in detail with reference to the drawings.

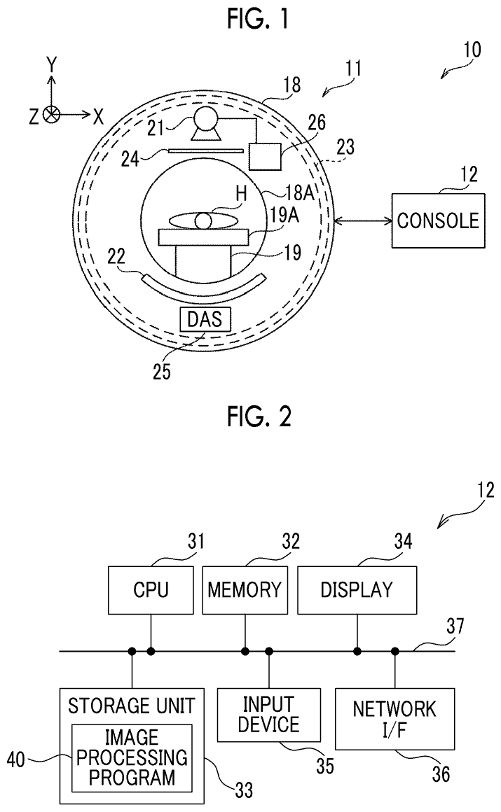

First, a configuration of a tomographic imaging system 10 will be described with reference to FIG. 1. As shown in FIG. 1, the tomographic imaging system 10 according to the present embodiment comprises a CT apparatus 11 and a console 12.

The CT apparatus 11 obtains a tomographic image of a subject H by imaging the subject H using X-rays, which are an example of radiation. The CT apparatus 11 is an example of a tomographic imaging apparatus according to the disclosed technology. A CT image captured by the CT apparatus 11 is configured to include a plurality of tomographic images. The CT apparatus 11 comprises a gantry 18 and a bed apparatus 19. FIG. 1 is a diagram in which the gantry 18 and the bed apparatus 19 are viewed from the front side. The bed apparatus 19 comprises a tabletop 19A on which the subject H can be placed in a decubitus posture. In the following description, a longitudinal direction of the tabletop 19A is referred to as a Z-axis direction, a lateral direction of the tabletop 19A is referred to as an X-axis direction, and a vertical direction is referred to as a Y-axis direction. The tabletop 19A is movable in the Z-axis direction in a state of being kept horizontal. The gantry 18 has an annular shape as a whole, and a circular opening portion 18A having a diameter larger than a width of the tabletop 19A is formed in the center. In a case of imaging, the tabletop 19A on which the subject H is placed is moved in the Z-axis direction with respect to the gantry 18 to enter the opening portion 18A. The imaging is performed while the tabletop 19A is moved with respect to the gantry 18.

A radiation source 21, a radiation detector 22, and a frame 23 are disposed inside the gantry 18. The radiation source 21 emits radiation toward the subject H. The radiation detector 22 detects the radiation transmitted through the subject H. The radiation transmitted through the subject H is attenuated by interaction (for example, absorption, scattering, and the like of the radiation) with structures such as organs and bones in the body of the subject H. The structures each have an attenuation coefficient for radiation peculiar to the structures, and the radiation transmitted through the structures carries information reflecting the physical properties of the structures. The radiation detector 22 detects the radiation in which the physical properties of the structure in the body of the subject H are reflected. The radiation detector 22 has a detection surface in which detection elements are two-dimensionally arranged, and outputs a detection signal for each detection element. Therefore, the radiation detector 22 can detect the radiation at each transmission position transmitted through the structure of the subject H. In addition, the radiation detector 22 has a substantially arcuate shape in accordance with the curvature of the gantry 18, and the detection surface is also curved.

The radiation source 21 and the radiation detector 22 are disposed at positions facing each other in the gantry 18 and rotate about the Z axis while maintaining the facing posture. The frame 23 has an annular shape and supports the radiation source 21 and the radiation detector 22 to be rotatable. In a case of imaging, the gantry 18 acquires detection signals by the radiation detector 22 at a plurality of positions in a circumferential direction about the Z axis corresponding to the body axis of the subject H while rotating the radiation source 21 and the radiation detector 22 about the subject H on the tabletop 19A. During the imaging, the tabletop 19A also moves in the Z-axis direction in synchronization with the rotation of the radiation source 21 and the radiation detector 22.

A data acquisition system (DAS) 25 collects the detection signal output by the radiation detector 22, generates output data at each position about the Z axis based on the collected detection signal, and outputs the generated output data to the console 12. In a case where the subject H is present between the radiation source 21 and the radiation detector 22, the output data is projection data obtained by projecting the subject H.

An irradiation field limiter 24 (also referred to as a collimator) that limits an irradiation field of radiation is disposed in front of the radiation source 21 in an irradiation direction. The irradiation field limiter 24 has an irradiation opening of which a contour is defined by a plurality of shielding plates that shield the radiation, and a size of the irradiation opening can be changed by moving the shielding plates. A voltage is supplied to the radiation source 21 from a high-voltage generator 26. The radiation source 21 and the radiation detector 22 are electrically connected to the frame 23 by a slip ring method, and, for example, power supply, transmission and reception of data, and the like are performed via the slip ring. The connection by the slip ring method allows the radiation source 21 and the radiation detector 22 to perform imaging of a helical scan method in which imaging is performed while rotating in one direction without reversing the rotation direction.

The console 12 controls the radiation source 21 and the radiation detector 22 via a control device (not shown) provided in the gantry 18. The console 12 is an example of an image processing apparatus according to the disclosed technology. The imaging conditions of the CT apparatus 11 are set by the operation from the console 12. The imaging condition includes irradiation conditions of the radiation from the radiation source 21, an imaging range, and the like. The irradiation condition of the radiation includes a tube voltage (unit: kV) to be applied to the radiation source 21, a tube current (unit: mA), and an irradiation time (unit: msec) of the radiation. The imaging range is adjusted, for example, by changing the size of the irradiation opening of the irradiation field limiter 24 in the X-Z plane, and is adjusted by changing the movement range of the tabletop 19A in the Z-axis direction.

A hardware configuration of the console 12 according to the present embodiment will be described with reference to FIG. 2. Examples of the console 12 include a computer, such as a personal computer or a server computer. As shown in FIG. 2, the console 12 includes a central processing unit (CPU) 31, a memory 32 as a temporary storage area, and a non-volatile storage unit 33. In addition, the console 12 includes a display 34 such as a liquid-crystal display, an input device 35 such as a keyboard and a mouse, and a network interface (I/F) 36 connected to the CT apparatus 11. The CPU 31, the memory 32, the storage unit 33, the display 34, the input device 35, and the network I/F 36 are connected to a bus 37. The CPU 31 is an example of a processor according to the disclosed technology.

The storage unit 33 is implemented by using a hard disk drive (HDD), a solid state drive (SSD), a flash memory, and the like. The storage unit 33 as a storage medium stores an image processing program 40. The CPU 31 reads out the image processing program 40 from the storage unit 33, loads the image processing program 40 in the memory 32, and executes the loaded image processing program 40.

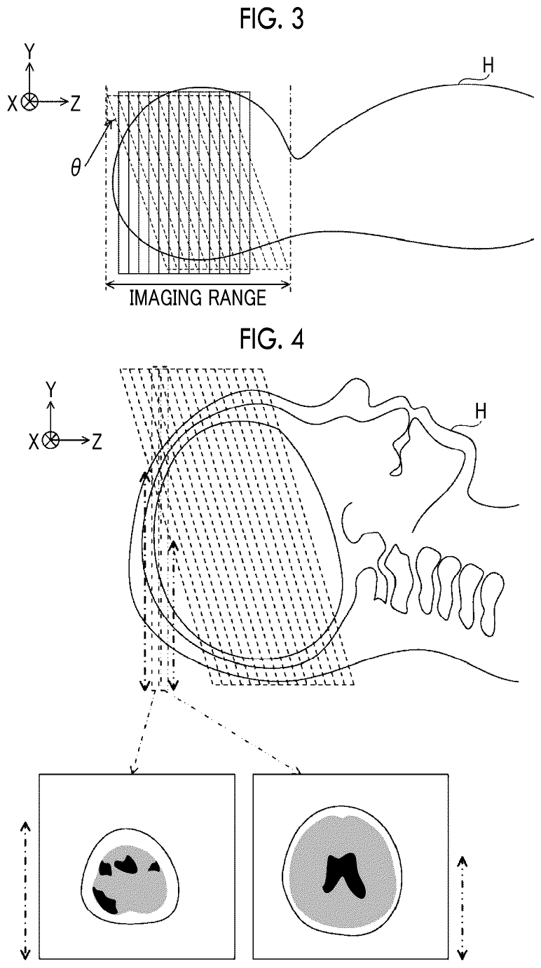

As shown in FIG. 3 as an example, the console 12 according to the present embodiment generates a tilt image, which is an image of an inclined cross section, by tilt-rotating a tomographic image representing an axial cross section obtained by imaging the subject H with the CT apparatus 11. The example of FIG. 3 shows a case in which the site to be imaged by the CT apparatus 11 is the head. In addition, in the example of FIG. 3, an area between two straight one-dot chain lines indicates an imaging range in the Z-axis direction, and each of the solid-line rectangles indicates an axial cross section. In addition, in the example of FIG. 3, each of the parallelograms of broken lines indicates an inclined cross section. The tilt rotation means rotation about the X-axis, and the example of FIG. 3 shows a case in which the axial cross section is tilt-rotated by an angle θ.

As shown in FIG. 4 as an example, in a case where the tilt image is generated by tilt-rotating the tomographic image representing the axial cross section, a range not used for generating the tilt image is present in some of the tomographic images. In the example of FIG. 4, each of the rectangle of a one-dot chain line and the rectangle of a two-dot chain line indicates an axial cross section, and an image at the tip of an arrow with each of the rectangle of the one-dot chain line and the rectangle of the two-dot chain line as a starting point indicates a tomographic image corresponding to each axial cross section. In addition, a double-headed arrow of the one-dot chain line and a double-headed arrow of the two-dot chain line indicate a range in a Y-axis direction (up-down direction in the tomographic image) not used for generating the tilt image in each tomographic image.

In a case where the tilt image is generated based on the tomographic image after the imaging of the tomographic image, the user may recognize that image quality of the tilt image does not satisfy image quality required for image interpretation after the generation of the tilt image. The image quality required for the image interpretation referred to here includes, for example, that the site necessary for the interpretation is captured in the tilt image. In this case, the user cannot determine whether or not to perform re-imaging the tomographic image until the generation of the tilt image is completed, and thus the subject H has to wait until the generation of the tilt image is completed. Therefore, the console 12 according to the present embodiment has a function of allowing the user to check whether or not the tilt image can be appropriately generated before the generation of the tilt image.

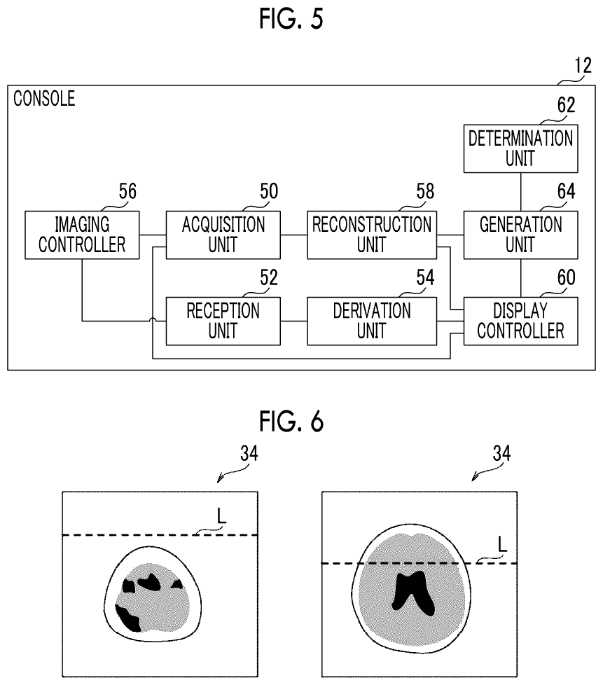

Next, a functional configuration of the console 12 will be described with reference to FIG. 5. As shown in FIG. 5, the console 12 includes an acquisition unit 50, a reception unit 52, a derivation unit 54, an imaging controller 56, a reconstruction unit 58, a display controller 60, a determination unit 62, and a generation unit 64. The CPU 31 executes the image processing program 40 to function as the acquisition unit 50, the reception unit 52, the derivation unit 54, the imaging controller 56, the reconstruction unit 58, the display controller 60, the determination unit 62, and the generation unit 64.

The acquisition unit 50 acquires the scout image obtained by the pre-imaging for determining the imaging range of the CT image from the CT apparatus 11. The scout image is, for example, a two-dimensional radiation image obtained by irradiating the side of the head of the subject H with radiation along the X-axis direction. In addition, the acquisition unit 50 sequentially acquires the projection data obtained under the control of the imaging controller 56, which will be described below, from the DAS 25.

The reception unit 52 receives the imaging range of the CT image input by the user based on the scout image and the angle θ for the tilt rotation. The derivation unit 54 derives the range used for generating the tilt image in the tomographic image based on the imaging range and the angle θ received by the reception unit 52. For example, the derivation unit 54 detects the site to be imaged by an image analysis method using artificial intelligence (AI), template matching, or the like on the scout image. Then, the derivation unit 54 derives the range used for generating the tilt image in the tomographic image by tilt-rotating the axial cross section within the imaging range in the detected site by the angle θ. The range excluding the derived range in the tomographic image is the range not used for generating the tilt image in the tomographic image.

The imaging controller 56 performs imaging using the helical scan method by controlling the movement of the tabletop 19A, the radiation source 21, and the radiation detector 22 in accordance with the imaging conditions including the imaging range received by the reception unit 52. With this control, the projection data is sequentially output from the DAS 25.

The reconstruction unit 58 generates the tomographic image representing the axial cross section by reconstructing the image based on the projection data acquired by the acquisition unit 50. The image is reconstructed based on the projection data by, for example, a filtered back projection method. In the present embodiment, the reconstruction unit 58 sequentially generates the tomographic image each time the acquisition unit 50 acquires the number of projection data items required for generating the tomographic image.

The display controller 60 performs control to display the scout image acquired by the acquisition unit 50 on the display 34. The user inputs the imaging range and the angle θ of the CT image with reference to the scout image displayed on the display 34 via the input device 35.

The display controller 60 performs a first control to display the tomographic image generated by the reconstruction unit 58 on the display 34. In addition, the display controller 60 performs a second control to display the range used for generating the tilt image in the tomographic image derived by the derivation unit 54 in an identifiable manner, in addition to the first control.

Specifically, as shown in FIG. 6 as an example, the display controller 60 performs, as the second control, a control to display an object indicating a boundary between a first range used for generating the tilt image and a second range not used for generating the tilt image, in the tomographic image. The example of FIG. 6 shows a case where the display controller 60 performs a control to display a broken line L as the object indicating the boundary between the first range and the second range in a superimposed manner on the tomographic image. In addition, in the example of FIG. 6, an upper side of the straight line L in the tomographic image is the first range, and a lower side thereof is the second range. In addition, the example of FIG. 6 shows two tomographic images representing two different axial cross sections. The object indicating the boundary between the first range and the second range is not limited to the broken line, and may be a straight line of a line type other than the broken line or an object other than the straight line.

The display controller 60 can perform control to display the generated tomographic image on the display 34 each time the tomographic image is sequentially generated by the reconstruction unit 58. In a case where the user performs an operation of switching the tomographic image to be displayed via the input device 35, the display controller 60 switches the tomographic image to be displayed on the display 34 and switches a display position of the straight line L to a position corresponding to the range derived by the derivation unit 54 for the tomographic image to be displayed, in response to the operation. That is, the display controller 60 sequentially performs the first control and the second control on each of the plurality of tomographic images during the imaging of the tomographic image. The imaging of the tomographic image referred to here means a period from the start of the imaging of the tomographic image (that is, the helical scanning) under the control of the imaging controller 56 to the input of the instruction information indicating the end of the imaging by the user.

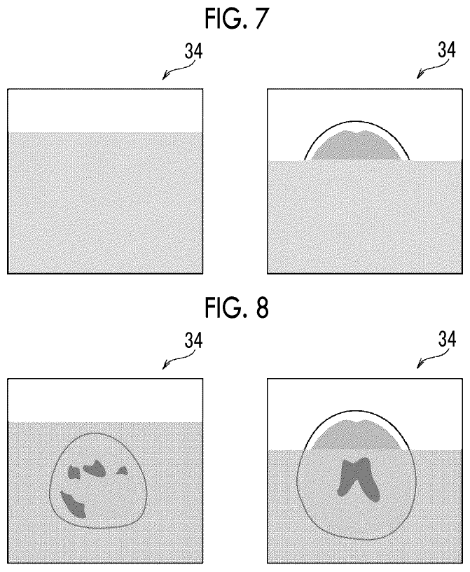

The display controller 60 may perform, as the second control, a control to display the first range used for generating the tilt image and the second range not used for generating the tilt image in different display modes, in the tomographic image. In this case, as the second control, the display controller 60 may cause the display modes of the first range and the second range to differ from each other by performing image processing in which visibility of the second range is lower than visibility of the first range. As shown in FIG. 7 as an example, the display controller 60 may perform image processing of displaying the first range in the tomographic image as it is and filling the second range with a preset color (gray in the example of FIG. 7) such that the visibility of the second range is lower than the visibility of the first range.

In addition, as shown in FIG. 8 as an example, the display controller 60 may perform image processing of displaying the first range in the tomographic image as it is and filling the second range with a preset color (gray in the example of FIG. 8) and a preset transmittance such that the visibility of the second range is lower than the visibility of the first range.

In addition, for example, the display controller 60 may perform, as the second control, a control to display the tomographic image in different display modes by making the brightness of the first range and the brightness of the second range in the tomographic image different from each other. The processing for causing the display modes to differ is not limited to the above-described examples as long as the first range and the second range in the tomographic image can be identified.

The display controller 60 performs control to display the tilt image generated by the generation unit 64, which will be described below, on the display 34.

The determination unit 62 determines whether the re-imaging of the tomographic image is necessary or unnecessary. In the present embodiment, the determination unit 62 determines that the re-imaging of the tomographic image is necessary in a case where the user inputs the instruction information indicating that the re-imaging is necessary via the input device 35. In addition, the determination unit 62 determines that the re-imaging of the tomographic image is unnecessary in a case where the user inputs the instruction information indicating that the re-imaging is unnecessary via the input device 35. The instruction information indicating that the re-imaging is unnecessary in this case may be instruction information indicating the end of the imaging of the tomographic image.

In a case where the determination unit 62 determines that the re-imaging of the tomographic image is unnecessary after the display controller 60 performs the first control and the second control, the generation unit 64 generates the tilt image based on the tomographic image generated by the reconstruction unit 58. In this case, the generation unit 64 generates the tilt image, which is the tomographic image of the inclined cross section inclined according to the angle θ received by the reception unit 52, by tilt-rotating the axial cross section using the tomographic image generated by the reconstruction unit 58. For example, the generation unit 64 generates the tilt image representing the inclined cross section inclined by rotating the tomographic image about the X-axis by the angle θ by performing the coordinate transformation using the rotation matrix corresponding to the angle θ.

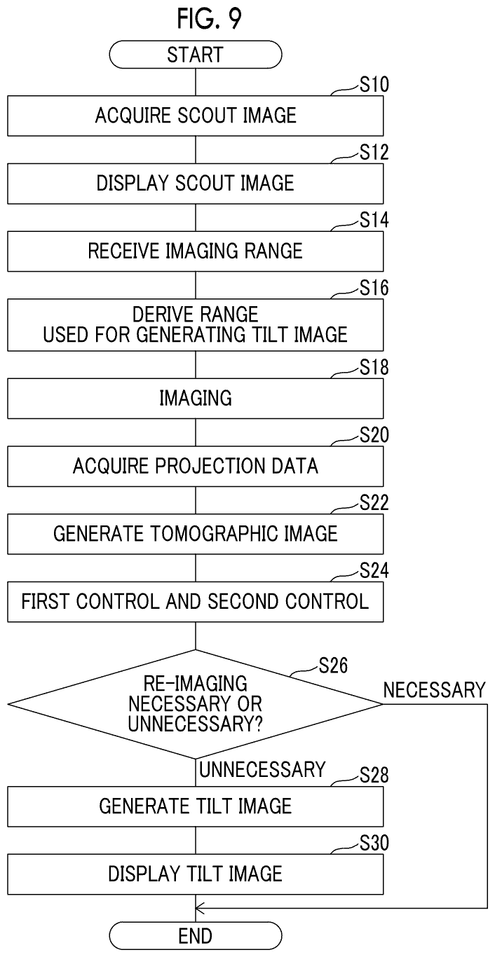

Subsequently, the operation and effect of the console 12 will be described with reference to FIG. 9. The tomographic imaging processing shown in FIG. 9 is executed by the CPU 31 executing the image processing program 40. The tomographic imaging processing is executed, for example, in a case where the user inputs an instruction to start the execution.

In step S10 of FIG. 9, the acquisition unit 50 acquires the scout image obtained by the pre-imaging for determining the imaging range of the CT image from the CT apparatus 11. In step S12, the display controller 60 performs control to display the scout image acquired in step S10 on the display 34. In step S14, the reception unit 52 receives the imaging range of the CT image input by the user based on the scout image displayed on the display 34 in step S10 and the angle θ for tilt rotation.

In step S16, the derivation unit 54 derives the range used for generating the tilt image in the tomographic image based on the imaging range and the angle θ received in step S14. In step S18, the imaging controller 56 performs the imaging using the helical scan method by controlling the movement of the tabletop 19A, the radiation source 21, and the radiation detector 22 in accordance with the imaging conditions including the imaging range received in step S14.

In step S20, the acquisition unit 50 sequentially acquires the projection data obtained by the control in step S18 from the DAS 25. In step S22, the reconstruction unit 58 generates the tomographic image representing the axial cross section by reconstructing the image based on the projection data acquired in step S20.

In step S24, the display controller 60 performs the first control to display the tomographic image generated in step S22 on the display 34. In addition, the display controller 60 performs the second control to display the range used for generating the tilt image in the tomographic image derived in step S16 in an identifiable manner, in addition to the first control. The user checks the display content of the display 34, checks whether or not the site necessary for image interpretation is used for generating the tilt image, and determines the necessity of re-imaging.

In step S26, the determination unit 62 determines whether the re-imaging of the tomographic image is necessary or unnecessary. In step S26, in a case where the determination unit 62 determines that the re-imaging is unnecessary, the process proceeds to step S28. In step S28, the generation unit 64 generates the tilt image based on the tomographic image generated in step S22.

In step S30, the display controller 60 performs control to display the tilt image generated in step S28 on the display 34. In a case where the process in step S30 is ended, the tomographic imaging processing is ended. On the other hand, in step S26, in a case where the determination unit 62 determines that the re-imaging is necessary, the tomographic imaging processing is ended without executing step S28 and step S30. In this case, for example, the user specifies a cause of the necessity of the re-imaging, such as the misregistration of the subject H, and inputs the instruction information for starting the execution of the tomographic imaging processing again after eliminating the cause.

As described above, according to the present embodiment, the user can check the range used for generating the tilt image in the tomographic image before the generation of the tilt image. Therefore, the user can check whether or not the tilt image can be appropriately generated before the generation of the tilt image. Therefore, it is possible to check whether or not the tilt image can be appropriately generated without keeping the subject H waiting until the generation of the tilt image is ended.

In the above-described embodiment, at least one of the functional units provided in the console 12 may be provided in another device, such as the control device provided in the gantry 18.

In addition, in the above-described embodiment, each process is executed by any computer. In addition, any computer may execute these processes using a processor as hardware, a program as software, or a combination thereof. In such a case, the processor is configured to execute various processes in the above-described embodiment in cooperation with the program, and may function as each unit or each means in the above-described embodiment. Further, the execution order of the processes by the processor is not limited to the order described and may be changed as appropriate. Any computer may be a general purpose computer, a special purpose computer, a workstation, or other system capable of executing each process.

The processor may be configured by one or more kinds of hardware, and the type of hardware is not limited. For example, the processor may be configured by a programmable logic device such as a central processing unit (CPU), a micro processing unit (MPU), or a field programmable gate array (FPGA), a dedicated circuit for executing specific processing, such as an application specific integrated circuit (ASIC), or hardware such as a graphic processing unit (GPU) or a neural processing unit (NPU). Additionally, the type of hardware may be a combination of different types of hardware. In a case where a plurality of pieces of hardware are configured to execute one or a plurality of types of processing of a processor, the plurality of pieces of hardware may be present in apparatuses physically separated from each other, or may be present in the same apparatus. In addition, in any of the embodiments, the order of each processing by the processor is not limited to the above order, and may be appropriately changed. The hardware is configured by an electric circuit (circuitry) in which circuit elements such as semiconductor elements are combined.

Further, the program may be software, such as firmware or a microcode. In addition, the program may be, for example, a program module group, and each function thereof may be realized by a processor configured to execute each function. The program may be a program code or a plurality of code segments stored in one or a plurality of non-transitory computer-readable media (for example, storage media or other storages). The program may be divided and stored in a plurality of non-transitory computer-readable media present in apparatuses physically separated from each other. The program code or the code segments may represent any combination of procedures, functions, subprograms, routines, subroutines, modules, software packages, classes, instructions, data structures, or program statements. The program code or code segments may be connected to other code segments or to hardware circuits by transmitting and receiving information, data, arguments, parameters, or contents of memory.

In the above embodiment, the image processing program 40 is described as being stored (installed) in the storage unit 33 in advance, but the present disclosure is not limited thereto. The image processing program 40 may be provided in a form recorded in a recording medium such as a compact disc read-only memory (CD-ROM), a digital versatile disc read-only memory (DVD-ROM), and a universal serial bus (USB) memory. Further, the image processing program 40 may also be downloaded from an external device via the network. In addition, the image processing program 40 can be provided as a program product. The program product includes products in any aspect for providing the program. For example, the program product includes a program provided through a network such as the Internet, and non-transitory computer-readable recording media such as a CD-ROM and a DVD in which the program is stored.

The following supplementary notes are further disclosed with respect to the above embodiment.

Supplementary Note 1

An image processing apparatus that generates a tilt image, which is an image of an inclined cross section inclined by tilt-rotating a tomographic image representing an axial cross section obtained by imaging a subject with a tomographic imaging apparatus, the image processing apparatus including:
a processor,
in which the processor is configured to: perform a first control to display the tomographic image and perform a second control to display a range used for generating the tilt image in the tomographic image in an identifiable manner.

### Supplementary Note 2

The image processing apparatus according to Supplementary Note 1,
in which the processor is configured to: perform, as the second control, control to display an object indicating a boundary between a first range and a second range in the tomographic image, the first range being used for generating the tilt image and the second range not being used.

### Supplementary Note 3

The image processing apparatus according to Supplementary Note 1,
in which the processor is configured to: perform, as the second control, control to display, in the tomographic image, a first range used for generating the tilt image and a second range not used in different display modes.

### Supplementary Note 4

The image processing apparatus according to Supplementary Note 3,
in which the processor is configured to: cause the display modes of the first range and the second range to differ from each other by performing image processing in which visibility of the second range is lower than visibility of the first range.

Supplementary Note 5

The image processing apparatus according to any one of Supplementary Notes 1 to 4,
in which the processor is configured to: sequentially perform the first control and the second control on each of a plurality of the tomographic images during imaging of the tomographic images.

### Supplementary Note 6

The image processing apparatus according to any one of Supplementary Notes 1 to 5,
in which the processor is configured to: generate the tilt image based on the tomographic image in a case where it is determined that re-imaging of the tomographic image is unnecessary after the first control and the second control are performed.

Supplementary Note 7

An image processing method executed by a processor included in an image processing apparatus that generates a tilt image, which is an image of an inclined cross section inclined by tilt-rotating a tomographic image representing an axial cross section obtained by imaging a subject with a tomographic imaging apparatus, the image processing method comprising:
performing a first control to display the tomographic image and performing a second control to display a range used for generating the tilt image in the tomographic image in an identifiable manner.

Supplementary Note 8

An image processing program causing a processor included in an image processing apparatus that generates a tilt image, which is an image of an inclined cross section inclined by tilt-rotating a tomographic image representing an axial cross section obtained by imaging a subject with a tomographic imaging apparatus, to execute a process comprising:
performing a first control to display the tomographic image and performing a second control to display a range used for generating the tilt image in the tomographic image in an identifiable manner.

What is claimed is:

1. An image processing apparatus that generates a tilt image, which is an image of an inclined cross section inclined by tilt-rotating a tomographic image representing an axial cross section obtained by imaging a subject with a tomographic imaging apparatus, the image processing apparatus comprising:
a processor,
wherein the processor is configured to: perform a first control to display the tomographic image and perform a second control to display a range used for generating the tilt image in the tomographic image in an identifiable manner.

2. The image processing apparatus according to claim 1,
wherein the processor is configured to: perform, as the second control, control to display an object indicating a boundary between a first range and a second range in the tomographic image, the first range being used for generating the tilt image and the second range not being used.

3. The image processing apparatus according to claim 1,
wherein the processor is configured to: perform, as the second control, control to display, in the tomographic image, a first range used for generating the tilt image and a second range not used in different display modes.

4. The image processing apparatus according to claim 3,
wherein the processor is configured to: cause the display modes of the first range and the second range to differ from each other by performing image processing in which visibility of the second range is lower than visibility of the first range.

5. The image processing apparatus according to claim 1,
wherein the processor is configured to: sequentially perform the first control and the second control on each of a plurality of the tomographic images during imaging of the tomographic images.

6. The image processing apparatus according to claim 1,
wherein the processor is configured to: generate the tilt image based on the tomographic image in a case where it is determined that re-imaging of the tomographic image is unnecessary after the first control and the second control are performed.

7. An image processing method executed by a processor included in an image processing apparatus that generates a tilt image, which is an image of an inclined cross section inclined by tilt-rotating a tomographic image representing an axial cross section obtained by imaging a subject with a tomographic imaging apparatus, the image processing method comprising:
performing a first control to display the tomographic image and performing a second control to display a range used for generating the tilt image in the tomographic image in an identifiable manner.

8. A non-transitory computer-readable storage medium storing an image processing program causing a processor included in an image processing apparatus that generates a tilt image, which is an image of an inclined cross section inclined by tilt-rotating a tomographic image representing an axial cross section obtained by imaging a subject with a tomographic imaging apparatus, to execute a process comprising:
performing a first control to display the tomographic image and performing a second control to display a range used for generating the tilt image in the tomographic image in an identifiable manner.
